(19) United States
(12) Patent Application Publication
(10) Pub. No.: US 2023/0071772 A1
(43) Pub. Date: Mar. 9, 2023

(54) PORTS TO SECURE CONNECTORS

(71) Applicant: HEWLETT-PACKARD DEVELOPMENT COMPANY, L.P., Spring, TX (US)

(72) Inventors: Hai-Lung Hung, Taipei City (TW); Cheng-Yi Yang, Taipei City (TW); Po Cheng Liao, Taipei City (TW)

(73) Assignee: HEWLETT-PACKARD DEVELOPMENT COMPANY, L.P., Spring, TX (US)

(21) Appl. No.: 17/796,747

(22) PCT Filed: Jan. 31, 2020
(86) PCT No.: PCT/US2020/016234

§ 371 Date: Aug. 1, 2022

(51) Int. Cl. H01R 13/639; H01R 24/60

(52) U.S. Cl. CPC H01R 13/6395; H01R 24/60

(57) ABSTRACT

Examples of electronic devices and connectors for providing a secure connection are described herein. In an example, an electronic device may securely hold an external device, upon engagement of a connector of the external device in a corresponding port of the electronic device.

### BACKGROUND

Electronic devices, such as full-sized desktop computers, all-in-one (AiO) computers, etc., include a port for being engaged with a connector of an external device, such as a mouse, a keyboard, a Universal Serial Bus (USB) Type-C hub, etc. The port and the connector may include corresponding features for engagement of an electronic device with an external device.

### BRIEF DESCRIPTION OF FIGURES

The detailed description is provided with reference to the accompanying figures, wherein:

FIG. 1 illustrates an electronic device for providing a secure connection with a connector of an external device, according to an example;

FIG. 2A illustrates an electronic device and a connector of an external device in a disengaged state, according to an example;

FIG. 2B illustrates the connector of the external device in a locked state with the electronic device of FIG. 2A;

FIG. 2C illustrates the connector of the external device in a released state with the electronic device of FIG. 2A;

FIG. 3 illustrates a top view of an electronic device for providing a secure connection with a connector of an external device, according to an example;

FIG. 4A illustrates an electronic device and a connector of an external device in a disengaged state, according to an example;

FIG. 4B illustrates a top view of the connector of the external device in an engaged state with the electronic device of FIG. 4A;

FIG. 4C illustrates a top view of the connector of the external device in a locked state with the electronic device of FIG. 4A;

FIG. 4D illustrates a top view of the connector of the external device in a released state with the electronic device of FIG. 4A;

FIG. 5 illustrates a connector of an external device, according to an example;

FIG. 6 illustrates a top view of a connector of an external device, according to an example;

FIG. 7 illustrates a side view of a connector of an external device, according to an example;

FIG. 8A illustrates a top view of a connector of an external device, according to an example; and

FIG. 8B illustrates a side view of the connector of FIG. 8A.

### DETAILED DESCRIPTION

An electronic device, such as a full-sized desktop personal computer (PC), an all-in-one (AiO) PC, a printer, a television, etc., may include a port for being coupled with a connector of an external device. Examples of the port may include, but are not limited to, a Universal Serial Bus (USB) Type-C port, a Video Graphics Array (VGA) port, and a High-Definition Multimedia Interface (HDMI) port. In an example, the connector may be a male connector. The port and the connector may include compatible features, such as holes and pins, to engage with each other. Due to frequent and prolonged connection between the port and the connector, such compatible features may become prone to deform or damage.

The deformation or damaging of the compatible features may cause a loose connection between the port and the connector. As a result, the connector may get detached from the port which may hinder an ongoing activity of the electronic device, thereby resulting in data loss.

In certain electronic devices, such as in an AiO PC, a full-sized desktop PC, a smart television, etc., the port may be provided at a rear panel which may be inconvenient for a user to access frequently. To avoid frequent accessing of the port at the rear panel, an extension device, such as a USB Type-C hub, a USB Type-C docking station, etc., may be connected to the port. The extension device may be placed at a conveniently accessible location for a user for connecting multiple peripheral devices with the electronic device. In such a connection, power signals and data signals from the multiple peripheral devices are exchanged with the electronic device through a connector of the extension device.

In an example, the connector of the extension device may not be securely connected with the port. Therefore, any accidental or unintentional detachment of the extension device from the port may cause disconnection of the multiple peripheral devices. This may result in hinderance in an ongoing activity of the multiple peripheral devices.

The present subject matter describes example electronic devices and connectors to provide secure connection with an external device. The electronic device may include a port that may be accessed through a housing of the electronic device. For example, the port may act as an interface between the electronic device and the external device. Further, the electronic device may include a securing element to securely hold a connector of the external device in the port. The securing element may be movable between a lock state and a release state. For example, when the connector is engaged with the port of the electronic device, the securing element may be moved into the lock state, to secure the connector in the port. The securing element may prevent any loose connection or accidental disconnection of the connector from the port. In the release state, the securing element may be moved to unlock the connector for being decoupled from the port.

In an example implementation, the present subject matter describes a connector, such as a USB Type-C connector. The connector may couple with the port of the electronic device. The connector may include a body member and a plug extending outwards from the body member. Further, the body member may include a groove. Upon insertion of the connector in the port, the groove may provide a secure connection between the connector and the port. Thus, the securing element of the electronic device and the groove of the connector may facilitate in avoiding any accidental disconnection of the external device from the electronic device.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

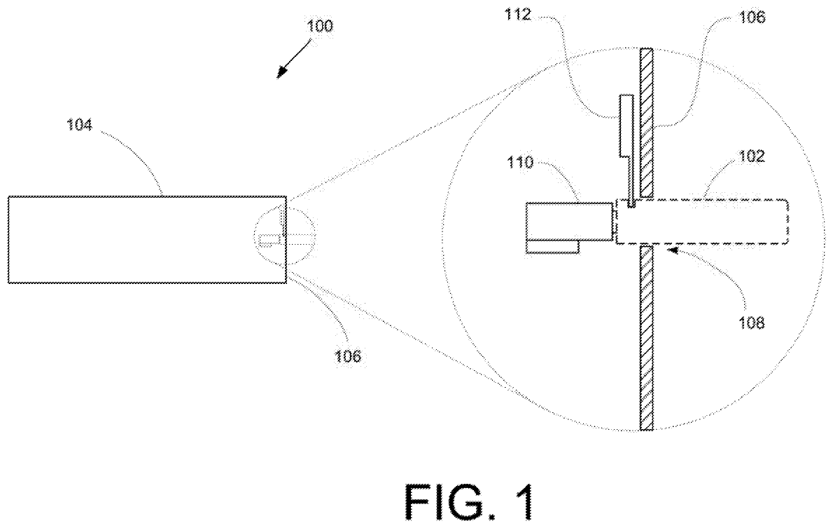

The manner in which the electronic device and connector are implemented are explained in detail with respect to FIGS. 1-8B. While aspects of described electronic device and connector can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates an electronic device 100 for providing a secure connection with a connector 102 of an external device (not shown), according to an example. Examples of the electronic device 100 may include, but are not limited to a laptop computer, a television, printer, and a desktop personal computer (PC) such as an all-in-one (AiO) PC and/or a full-sized desktop PC. The electronic device 100 may include a housing 104. The housing 104 may form an enclosure to hold various components of the electronic device 100. For example, the components may include a printed circuit board, a processing unit, a power supply unit, etc.

Further, the housing 104 may have a wall 106. The wall 106 may be a panel conjoined with other such panels of the housing 104 for encasing the components of the electronic device 100. Further, the wall 106 may include an opening 108. The electronic device 100 may also include a port 110 accessible through the opening 108 in the wall 106. In an example, the port 110 may provide an interface between the electronic device 100 and the connector 102. The port 110 may act as a point of attachment where the connector 102 may be plugged. In an example, the opening 108 may be aligned with the port 110 so as to provide access to the connector 102 for being coupled with the port 110.

The electronic device 100 may further include a securing element 112. The securing element 112 may facilitate in providing a secure connection between the port 110 and the connector 102. The securing element 112 may be movably disposed along the wall 106. For example, to establish a connection between the external device and the electronic device 100, the connector 102 may be engaged with the port 110. Upon engagement of the connector 102, the securing element 112 may be moved to a lock state to securely hold the connector 102 within the port 110.

In an example, the securing element 112 may be designed such that, upon insertion of the connector 102 into the port 110, one end of the securing element 112 may couple with the connector 102. The coupling of the securing element 112 with the connector 102 may securely hold the connector 102 into the port 110.

Accordingly, the present subject matter facilitates a secure connection between the connector 102 of the external device and the port 110 of the electronic device 100. The secure connection so provided may prevent any accidental or unintentional disconnections between the electronic device 100 and the external device. As a result, any data loss resulting due to such disconnections may be prevented in the electronic device 100.

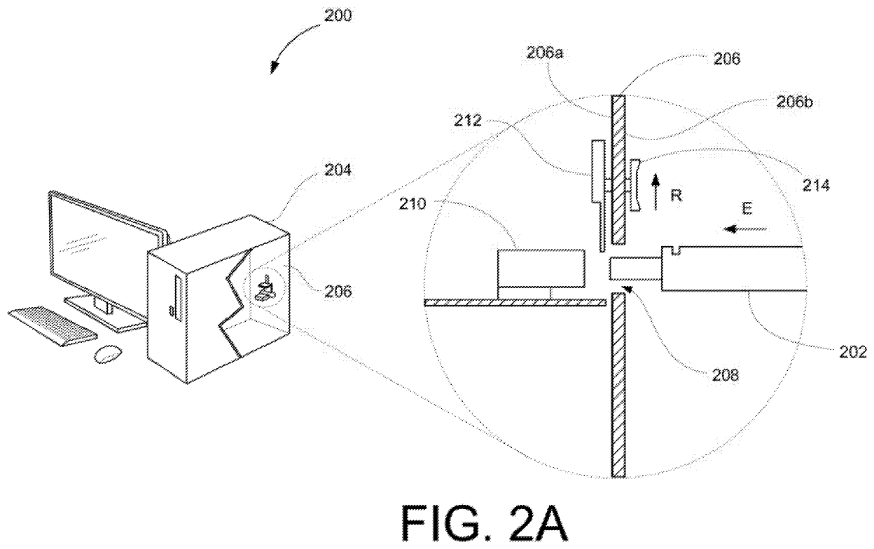

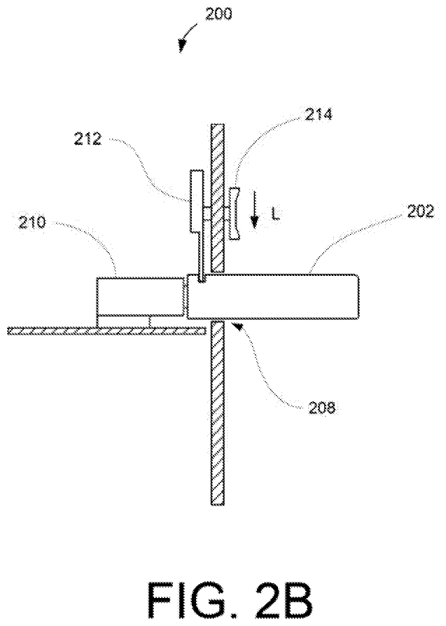

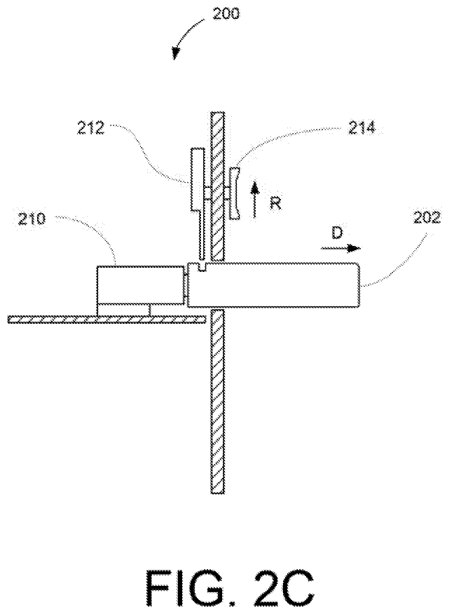

FIG. 2A illustrates an electronic device 200 and a connector 202 of an external device (not shown) in a disengaged state, according to an example. The disengaged state may be a state in which the external device is yet to be engaged with the electronic device 200.

The electronic device 200 may be similar to the electronic device 100. Accordingly, the electronic device 200 may include a housing 204. The housing 204 may include a wall 206 having an opening 208, similar to the wall 106 and the opening 108 of the electronic device 100. The electronic device 200 may further include a port 210 for enabling the external device to engage with the electronic device 200. The port 210 may be similar to the port 110 of the electronic device 100. In an example implementation, the port 210 may have a height of about 6.6 millimeters. The height of the port 210 may vary based on dimensions of the electronic device 200 in which the port 210 may be implemented.

In an example, the wall 206 may be a back cover of the electronic device 200. For example, in the case of an all-in one (AiO) PC, the port 210 may be provided on the back cover for providing connections with external devices. The port 210 may be directly provided on the back cover of the electronic device 200 or may be provided through a detachable panel mounted on the back cover.

The electronic device 200 may also include a securing element 212 that may be movably disposed on the wall 206, similar to the securing element 112 of the electronic device 100. In an example, the securing element 212 may be disposed at an internal surface 206a of the wall 206 such that the securing element 212 is concealed from the external device. In an example, in the disengaged state, the securing element 212 may extend along a portion of the opening 208 to block a path of the connector 202 when being inserted into the port 210.

Further, the electronic device 200 may include an actuating member 214 coupled to the securing element 212. For example, the actuating member 214 may be disposed on an external surface 206b of the wall 206. The actuating member 214 may facilitate a user to actuate a movement of the securing element 212 between the lock state and a release state. In an example, the actuating member 214 may be a mechanical switch. By manually actuating the mechanical switch, the user may move the securing element 212 between the lock state and the release state.

In an example implementation, the actuating member 214 may be formed of a magnetic material and the securing element 212 may be formed of a metallic material. Thus, the actuating member 214 may be magnetically coupled with the securing element 212. As a result, due to the magnetic force of the actuating member 214, the securing element 212 may be moved between the lock state and the release state, when the actuating member 214 may be moved between the lock state and the release state respectively.

In an example, FIG. 2A depicts the electronic device 200 as a full-sized desktop PC. In the case of the full-sized desktop PC, the housing 204 may be the housing of a central processing unit (CPU) which holds the components of the desktop PC.

As mentioned earlier, the securing element 212 may extend to block a path of the connector 202 through the opening 208. Therefore, before inserting the connector 202 in the port 210, the actuating member 214 may be moved in an upward direction as depicted by arrow ‘R’. The movement of the securing element 212 in the upward direction may make way for the connector 202 for being inserted into the port 210. In an example, the actuating member 214 may impart a translatory motion to the securing element 212, thereby causing the securing element 212 to move in the upward direction.

FIG. 2B illustrates the connector 202 of the external device in a locked state with the electronic device 200 of FIG. 2A. As mentioned with respect to FIG. 2A, the securing element 212 may be moved away from the opening 208 to allow the connector 202 for being inserted in the port 210. To lock the connector 202 with the port 210, the connector 202 may be inserted into the port 210. In an example, the connector 202 may include pins (not shown) that may engage with corresponding holes (not shown) of the port 210. Thereafter, the actuating member 214 may be actuated to move the securing element 212 in a direction opposite to the upward direction ‘R’, such as a downward direction as depicted by arrow ‘L’. The movement of the securing element 212 in the downward direction may lock the connector 202 within the port 210.

Although the movement of the securing element 212 has been depicted to be in the upward and downward directions, the movement of the securing element 212 may be in a lateral direction, such as in a left direction and a right direction.

In the locked state, the securing element 212 may provide a secure connection between the connector 202 and the port 210. In an example implementation, the securing element 212 may have an elongated body such that in the lock state, one end of the securing element 212 may get coupled to the connector 202. As a result, the securing element 212 may lock the connector 202 within the port 210. In the lock state, the securing element 212 may securely retain the connector 202 in the port 210.

FIG. 2C illustrates the connector 202 of the external device in a released state with the electronic device 200 FIG. 2A. In the present example, to remove the connector 202 from the port 210, the securing element 212 may be moved away from the connector 202. For example, the securing element 212 may be moved in the upward direction as depicted by arrow ‘R’, by the actuating member 214. The connector 202 may thereafter be pulled away, in a direction depicted by arrow ‘D’, from the port 210 to decouple the connector 202 from the port 210.

Although the securing element 212 has been depicted to have an elongated body, the securing element 212 may also have a disc-shaped body. For example, the disc-shaped body may include a protrusion extending radially outwards. The protrusion may get fixed with the connector 202 to lock the connector 202 with the port 210. In an example, rotation of the securing element 212 in a first direction (not shown), may couple the protrusion with the connector 202. Further, rotation of the securing element 212 in a second direction (not shown), opposite to that of the first direction, may detach the protrusion from the connector 202.

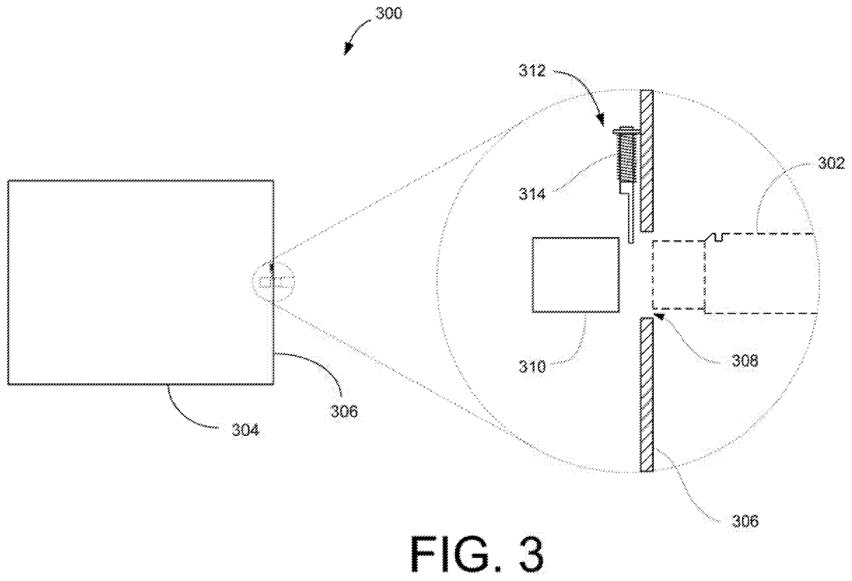

FIG. 3 illustrates a top view of an electronic device 300 for providing a secure connection with a connector 302 of an external device (not shown), according to an example. Examples of the electronic device 300 may include, but are not limited to a laptop computer, a television, printer, a desktop personal computer (PC) such as an all-in-one (AiO) PC and/or a full-sized desktop PC. The electronic device 300 may be similar to the electronic device 100. Further, the electronic device 300 may include an enclosure 304. The enclosure 304 may be provided to hold various components of the electronic device 300.

The enclosure 304 may include a side wall 306. The side wall 306 may be a panel conjoined with other such panels of the enclosure 304 for encasing the components of the electronic device 300. Further, the side wall 306 may include an opening 308. The opening 308 may be similar to the opening 108. The electronic device 300 may further include a port 310 accessible through the opening 308. In an example, the port 310 may provide an interface between the electronic device 300 and the connector 302. The port 310 may be similar to the port 110.

Further, the electronic device 300 may include a securing element 312. The securing element 312 may facilitate in providing a secure connection between the port 310 and the connector 302. The securing element 312 may be movably disposed along the side wall 306. The securing element 312 may be similar to the securing element 112. For example, the securing element 312 may be movable between a lock state and a release state to secure the connector 302 with the port 310 and for decoupling the connector 302 from the port 310, respectively.

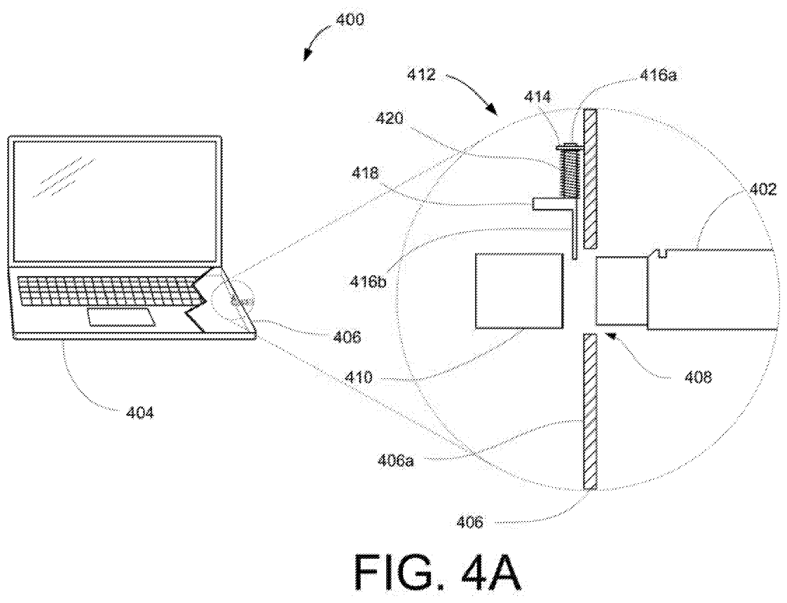

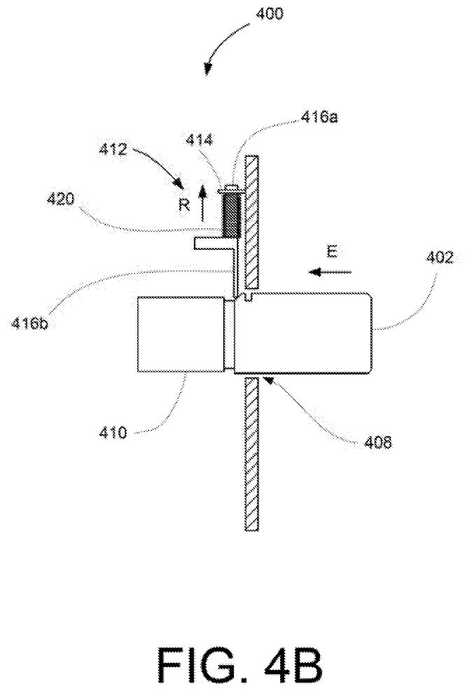

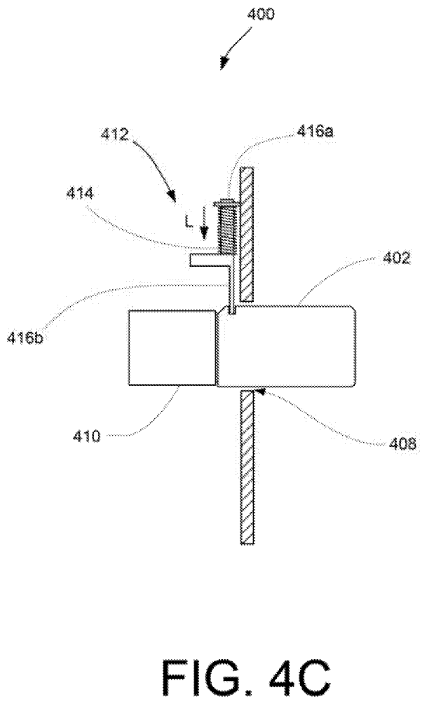

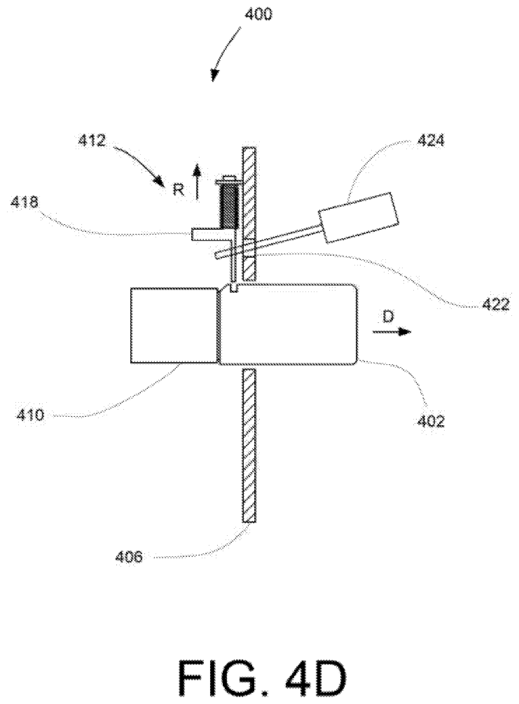

The electronic device 300 may also include a resilient member 314 coupled to the securing element 312. In an example, the resilient member 314 may be a spring. The resilient member 314 may un-bias upon movement of the securing element 312 in the lock state. Further, the resilient member 314 may bias upon movement of the securing element 312 in the release state. For example, movement of the securing element 312 with respect to insertion or removal of the connector 302 may compress and decompress the resilient member 314. The decompression of the resilient member 314 may apply a force on the securing element 312 in a longitudinal direction, thereby causing the securing element 312 to lock with the connector 302. Details pertaining to the movement of the securing element 312 are described in conjunction with FIGS. 4A-4D.

Accordingly, the resilient member 314 may facilitate insertion of the connector 302 into the port 310 without any manual actuation of the securing element 312. The securing element 312 may in turn securely engage the connector 302 with the port 310 to prevent any accidental or unintentional disconnections and any data loss resulting due to such disconnections.

FIG. 4A illustrates an electronic device 400 and a connector 402 of an external device (not shown) in a disengaged state, according to an example. The disengaged state may be a state in which the connector 402 is yet to be engaged with the electronic device 400. In an example, the connector 402 may be a Universal Serial Bus (USB) type-C plug. The electronic device 400 may be similar to the electronic device 300.

Further, the electronic device 400 may include an enclosure 404. The enclosure 404 may include a side wall 406 having an opening 408, similar to the side wall 306 and the opening 308 of the electronic device 300. In an example, the opening 408 may have a height of about 6.6 millimeters. The height of the opening 408 may vary based on dimensions of the electronic device 400 in which the opening 408 may be implemented.

The electronic device 400 may further include a port 410 for enabling the external device to engage with the electronic device 400. The port 410 may be similar to the port 310 of the electronic device 300. The port 410 may be a port of the electronic device 400 for connecting with the connector 402. The port 410 may be aligned with the opening 408 for being accessible to the external device.

The electronic device 400 may also include a securing element 412 that may be movably disposed on the side wall 406, similar to the securing element 312 of the electronic device 300. In an example, the securing element 412 may be disposed at an internal surface 406a of the side wall 406 such that the securing element 412 is concealed from outside. The securing element 412 may include a holder 414 for fixedly connecting the securing element 412 with the side wall 406. Further, the securing element 412 may include a top portion 416a and a bottom portion 416b. The top portion 416a may be movable with respect to the holder 414 in a longitudinal direction for locking and releasing the connector 402. In addition, the securing element 412 may include a flange 418. The flange 418 may be an arm extending outwards from the securing element 412 such that the flange 418 may separate the top portion 416a from the bottom portion 416b.

The electronic device 400 may further include a resilient member 420 coupled to the securing element 412, the resilient member 420 being similar to the resilient member 314 of the electronic device 300. In an example, the resilient member 420 may be wound around the top portion 416a of the securing element 412. Accordingly, the movement of the top portion 416a with respect to the holder 414 may un-bias and bias the resilient member 420 for locking and releasing the connector 402.

In the disengaged state as depicted in FIG. 4A, when the connector 402 is yet to be inserted into the port 410, the securing element 412 may extend into a portion of the opening 408 due to un-biasing of the resilient member 420. Accordingly, the securing element 412 may block a path of the connector 402 through the opening 408.

FIG. 4B illustrates a top view of the connector 402 of the external device in an engaged state with the electronic device 400 of FIG. 4A. As mentioned with respect to FIG. 4A, in the disengaged state the securing element 412 may not allow movement of the connector 402 into the electronic device 400. To engage the connector 402 and the port 410, the connector 402 may be inserted into the opening 408 for engaging with the port 410.

During the movement of the connector 402 in a direction as depicted by arrow ‘E’, the connector 402 may come in contact with the bottom portion 416b of the securing element 412. As a result, the bottom portion 416b may cause the top portion 416a to be pushed away from the connector 402 in a direction as depicted by arrow ‘R’. The movement of the top portion 416a with respect to the holder 414 may bias the resilient member 420 around the top portion 416a. Thus, upon engagement of the connector 402 with the port 410, a force may build up in the resilient member 420.

FIG. 4C illustrates a top view of the connector 402 of the external device in a locked state with the electronic device 400 of FIG. 4A. As mentioned with respect to FIG. 4B, the insertion of the connector 402 may move the securing element 412 away from the opening 408. When the connector 402 may be completely inserted into the port 410, the build-up force is released from the resilient member 420. As a result, the top portion 416a may be moved in a direction as depicted by arrow ‘L’. The movement of the top portion 416a may cause the bottom portion 416b to get coupled with the connector 402. Thus, the securing element 412 may get locked with the connector 402. In the lock state, the securing element 412 may provide a secure connection between the connector 402 and the port 410.

FIG. 4D illustrates a top view of the connector 402 of the external device in a released state with the electronic device 400 of FIG. 4A. In an example implementation, the side wall 406 may include a slot 422 to receive an actuating member 424 to facilitate a user to move the securing element 412 away from the connector 402. For example, to remove the connector 402 from the port 410, the user may move the securing element 412 away from the connector 402 by the actuating member 424. The actuating member 424 may be an external tool, such as a screw driver, for being inserted into the electronic device 400 through the slot 422.

Further, the flange 418 of the securing element 412 may be aligned with the slot 422 such that the actuating member 424 may abut with the flange 418 for movement of the securing element 412 in the release state. For example, the actuating member 424 may be inserted through the slot 422 for abutting with the flange 418. Upon abutment, the user may move the actuating member 424 to cause the securing element 412 to be moved in a direction as depicted by arrow ‘R’. The movement of the securing element 412 may unlock or release the connector 402. The connector 402 may thereafter be pulled away, in a direction as depicted by arrow from the port 410 to decouple the connector 402 from the port 410.

Although the securing element 412 has been depicted to have an elongated body, the securing element 412 may also have a disc-shaped body. For example, the disc-shaped body may include a protrusion extending radially outwards. The protrusion may get fixed with the connector 402 to lock the connector 402 with the port 410. In an example, rotation of the securing element 412 in a first direction (not shown), may couple the protrusion with the connector 402. Further, rotation of the securing element 412 in a second direction (not shown), opposite to that of the first direction, may detach the protrusion from the connector 402.

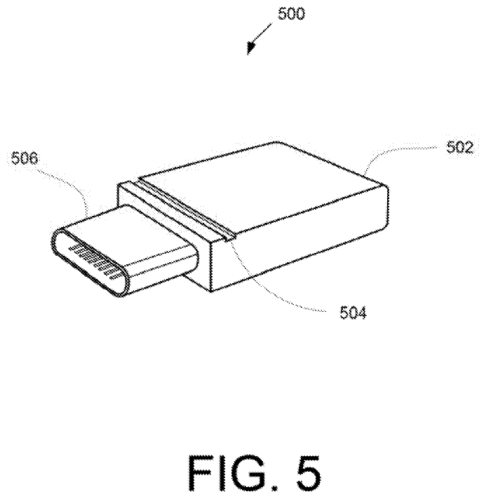

FIGS. 5 to 8B illustrate different views of connectors 500, 600, 700, and 800 of an external device (not shown), according to various examples. Examples of the connectors 500, 600, 700, and 800 may include, but are not limited to, a Universal Serial Bus (USB) Type-C port, a Video Graphics Array (VGA) port, and a High-Definition Multimedia Interface (HDMI) port. Examples of the external device may include a mouse, a keyboard, a USB Type-C hub, a USB Type-C docking station, etc.

Referring to FIG. 5, the connector 500 of the external device is illustrated, according to an example. In an example, the connector 500 may include a body member 502. The body member 502 may be a portion of the connector 500 by which a user may hold the connector 500 while inserting or removing the connector 500 from a corresponding port (not shown). In an example, the body member 502 may be made of a plastic material or a metallic material. Further, the connector 500 may include a groove 504 formed at an end portion of the body member 502. The groove 504 may be a depression or a cut formed in the body member 502 for being locked with a port of an electronic device.

The connector 500 may also include a plug 506 extending from the end portion of the body member 502. In an example, the plug 506 may extend longitudinally away from the end portion of the body member 502. In an example, the plug 506 may include communication pins for communicating power or data signals between the external device and an electronic device (not shown). Further, the end portion may be proximal to the groove 504 to provide a secure connection between the connector 500 and the corresponding port. For example, upon engagement of the connector 500 with the corresponding port, the groove 504 may facilitate in securely locking the connector 500 with a securing element (not shown) of the electronic device.

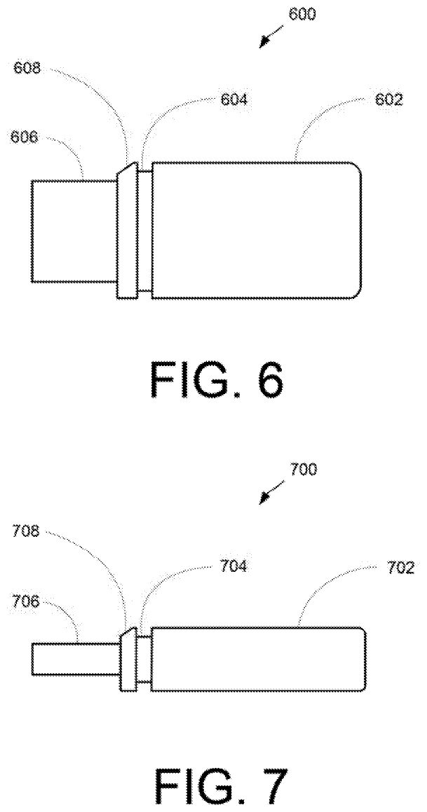

Referring to FIG. 6, a top view of the connector 600 of an external device (not shown) is illustrated, according to an example. The connector 600 may include a body member 602, similar to the body member 502. Further, the connector 600 may include a groove 604 formed at an end portion of the body member 602. In an example, the groove 604 may be a continuous groove formed around the body member 602. The connector 600 may also include a plug 606 extending from the end portion of the body member 602.

Further, according to an example, an edge 608 of the end portion of the connector 600 facing a corresponding port may be wedge shaped. For example, a lateral surface of the edge 608 may be wedge-shaped. Thus, the edge 608 may facilitate in inserting the connector 600 into an electronic device, such as the electronic device 100, 200, 300, and 400. For example, when the connector 600 is inserted into an opening of the electronic device, the edge 608 of the body member 602 may slide past a securing element of the electronic device. The sliding movement of the edge 608 may push the securing element away from the opening of the electronic device. As a result, the connector 600 may be inserted into the electronic device without any manual actuation of the securing element.

Referring to FIG. 7, a side view of the connector 700 of an external device (not shown) is illustrated, according to an example. The connector 700 may include a body member 702, similar to the body member 502. Further, the connector 700 may include a groove 704 formed at an end portion of the body member 702. In an example, the groove 704 may be a continuous groove formed around the body member 702. The connector 700 may also include a plug 706 extending outwards from the end portion of the body member 702.

Further, according to an example, an edge 708 of the end portion of the connector 700 facing a corresponding port may be wedge shaped. For example, a top surface of the edge 708 may be wedge-shaped. The wedge shape of the edge 708 may facilitate in inserting the connector 700 into an electronic device, such as the electronic device 100, 200, 300, and 400.

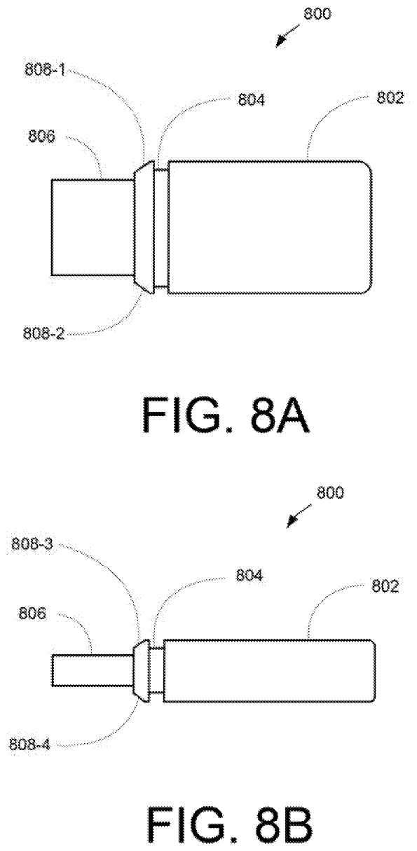

Referring to FIG. 8A, a top view of the connector 800 of an external device (not shown) is illustrated, according to an example. The connector 800 may include a body member 802, similar to the body member 502. Further, the connector 800 may include a groove 804 formed at an end portion of the body member 802. In an example, the groove 804 may be a continuous groove formed around the body member 802. The connector 800 may also include a plug 806 extending from the end portion of the body member 802.

Further, according to an example, a first lateral edge 808-1 and a second lateral edge 808-2 of the end portion of the connector 800 facing a corresponding port may be wedge shaped. Thus, the lateral edges 808-1 and 808-2 may facilitate in inserting the connector 800 into an electronic device, such as the electronic device 100, 200, 300, and 400.

Referring to FIG. 8B, a side view of the connector 800 of FIG. 8A is illustrated. According to an example, a top edge 808-3 and a bottom edge 808-4 of the end portion of the connector 800 facing a corresponding port may be wedge shaped. Thus, the top and bottom edges 808-3 and 808-4 may facilitate in smoothly inserting the connector 800 into an electronic device, such as the electronic device 100, 200, 300, and 400.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. An electronic device comprising:
a housing having a wall with an opening;
a port accessible through the opening in the wall, the port is to provide an interface between the electronic device and an external device; and
a securing element movably disposed along the wall, the securing element being movable to a lock state to secure a connector of the external device in the port, upon engagement of the external device into the port.

2. The electronic device as claimed in claim 1, wherein the securing element is movable to a release state for decoupling the connector from the port.

3. The electronic device as claimed in claim 2, wherein the electronic device comprises an actuating member coupled to the securing element to move the securing element between the lock state and the release state.

4. The electronic device as claimed in claim 3, wherein the securing element is formed of a metallic material and the actuating member is formed of a magnetic material.

5. The electronic device as claimed in claim 1, wherein the wall is a back cover of the electronic device.

6. The electronic device as claimed in claim 1, wherein the port has a height of about 6.6 millimeters.

7. An electronic device comprising:
an enclosure having a side wall, the side wall having an opening;
a port to couple with a connector of an external device through the opening;
a securing element movably disposed along the side wall, the securing element being movable between a lock state and a release state to secure the connector with the port and for decoupling the connector from the port, respectively; and
a resilient member coupled to the securing element, wherein the resilient member is to un-bias upon movement of the securing element in the lock state and to bias upon movement of the securing element in the release state.

8. The electronic device as claimed in claim 7, wherein the side wall includes a slot to receive an actuating member to move the securing element away from the connector, while the connector is being inserted in and removed from the port.

9. The electronic device as claimed in claim 8, wherein the securing element comprises a flange, the flange being aligned with the slot to abut with the actuating member for movement of the securing element in the release state.

10. The electronic device as claimed in claim 7, wherein the connector is a Universal Serial Bus (USB) type-C plug.

11. The electronic device as claimed in claim 7, wherein the opening has a height of about 6.6 millimeters.

12. A connector comprising:
a body member having a groove at an end portion of the body member; and
a plug extending from the end portion of the body member, the end portion being proximal to the groove, the plug is to engage with a corresponding port of an electronic device,
wherein upon insertion of the body member into the electronic device, the groove is to securely hold the connector in the electronic device.

13. The connector as claimed in claim 12, wherein the groove is a continuous groove.

14. The connector as claimed in claim 12, wherein the connector is a Universal Serial Bus (USB) type-C connector.

15. The connector as claimed in claim 12, wherein an edge of the end portion facing the corresponding port is wedge shaped to allow engagement of the plug with the corresponding port.
